(19) United States
(12) Patent Application Publication
(10) Pub. No.: US 2010/0109387 A1
(43) Pub. Date: May 6, 2010

(54) Seat for a means of transport

(75) Inventor: Harald MERENSKY, Hamburg (DE)

Correspondence Address: MORRISON & FOERSTER LLP, 1650 TYSONS BOULEVARD, SUITE 400, MCLEAN, VA, 22102, US

(73) Assignee: Lufthansa Technik AG, Hamburg (DE)

(21) Appl. No.: 12/578,331

(22) Filed: Oct. 13, 2009

(30) Foreign Application Priority Data
Oct. 14, 2008 (DE) 10 2008 051 603.1

(51) Int. Cl. B60N 2/24; A47C 7/50; B60N 2/02; A47C 1/00; B60N 2/01; B64D 11/06; B60N 2/22; B60N 2/44; B60N 2/64

(52) U.S. Cl. 297/75; 297/423.19; 297/423.3; 297/353; 297/340; 297/243

(57) ABSTRACT

A seat and a seat system for a means of transport. The seat includes a seat surface, a backrest, and an adjustable leg support and/or foot support arranged in the region in front of the seat surface. The leg support and/or foot support is configured to be divided in the longitudinal direction into two parts, and the two parts are configured to be adjustable separately.

### REFERENCE TO RELATED APPLICATIONS

This application claims the priority of German Patent Application No. 10 2008 051 603.1, filed Oct. 14, 2008, the contents of which are incorporated herein by reference.

### FIELD OF THE INVENTION

The invention relates to a seat for a means of transport comprising a seat surface, a backrest and an adjustable leg support and/or foot support arranged in the region in front of the seat surface. The subject of the invention is, moreover, an arrangement of a plurality of seats according to the invention arranged behind one another.

### BACKGROUND OF THE INVENTION

In commercial long-haul aircraft, the comfort in first and business class has been progressively improved over the past few years. Whilst, for example, a few years ago, in business class a conventional seat pitch was still 1.27 m, it has since increased to 1.60 m or more. In contrast, improved use of space is a priority in economy class so that over the same time period seat pitches have reduced. A conventional seat pitch in economy class in long-haul aircraft is, for example, frequently in the region of 81 cm. In a few airlines, a fourth class has been established between business and economy class, which is frequently denoted as premium economy and, for example, may have seat pitches of between approximately 90 and 110 cm.

### SUMMARY OF THE INVENTION

The object of the invention is to provide a seat as well as a seat arrangement of the type mentioned in the introduction, which permits improved seat comfort even with small seat pitches which, for example, are common in economy or premium economy class on long-haul aircraft.

This object is achieved by the invention in that the leg support and/or foot support is configured to be divided in the longitudinal direction and the two parts are configured to be adjustable separately.

Firstly, a few terms used within the scope of the invention might be explained. The invention relates to a seat for a means of transport. The means of transport may, in particular, be a public means of transport, such as for example an aircraft, rail-mounted vehicle or bus. In the region in front of the seat surface an adjustable leg support and/or foot support is arranged. Directional information, such as for example “in front” refers within the scope of this description and patent claims to the viewing direction of a passenger seated as intended in the seat. Accordingly, the division of the leg support and/or foot support in the longitudinal direction means that the division extends in the viewing direction of such a passenger. The term leg support and/or foot support denotes a device arranged in front of the seat surface, which may serve to support the legs (for example the lower leg) or—dependent on the adopted position to be explained in more detail below—also the feet. The leg support and/or foot support thus has two parts and/or halves as a result of the division in the longitudinal direction, which are configured to be adjustable separately. The adjustability according to the invention preferably encompasses, in particular, an adjustability of the height and/or inclination of the support surface. “Adjustable separately” means that the two parts may be moved independently of one another into a desired position for supporting the respective leg and/or foot. Thus, as will be explained in more detail in the description of the figures, for example one half may be adjusted forward as an extension of the seat surface to be used in this manner as a foot support for a leg which is drawn-up, whilst the other half produces a support surface inclined obliquely downwards, in particular for the lower leg. In this manner, seating positions may be adopted in which a greater proportion of the surface of the body of the passenger is directly supported than in conventional seating positions in an economy seat. This permits improved muscular relaxation and makes it easier for the passenger to relax and, for example, to sleep on long-haul journeys and/or flights. The invention has thus recognized that by the design of a seat according to the invention, even with the relatively constricted space conditions of economy or premium economy class and the typically extremely small seat pitches, seating positions may be adopted which permit a more relaxed seating position.

According to the invention, preferably the leg support and/or foot support is pivotably articulated in the region of the front edge of the seat surface. It may, for example, for take off and landing be folded away substantially vertically downwards from the seat front edge; then during the flight one half or both longitudinally divided halves of this leg support and/or foot support may be folded upwards to the desired extent. The leg support and/or foot support may be able to be moved into a resting position, in which it forms a substantially horizontal support surface for the legs and/or feet. In this connection it may preferably be arranged approximately at the same height as the seat surface. It forms in this position an extension of the seat surface to the front. As typical seat pitches in economy or premium economy do not permit the legs to be stretched straight out on said seat surface extended to the front, in this connection, for example, a position may be adopted by the passenger with drawn-up legs in which the feet are placed on this leg support and/or foot support. This is also explained in more detail in the description of the figures. The height of the substantially horizontal support surface of the leg support and/or foot support in the resting position preferably corresponds—as already explained—to the height of the seat surface and may, for example, be in the range of 30 to 60 cm, further preferably 40 to 50 cm above the floor. The floor is, in this case, the cabin floor of the aircraft and/or of the respective means of transport.

According to the invention, additionally the front region of the seat surface may be configured to be height-adjustable. In this connection, it is possible that this front region of the seat surface is, for example, lifted upwards and is then located higher than the adjacent horizontal support surface of the leg support and/or foot support in the resting position. The seat surface lifted to the front forms in this manner an improved support surface for the bottom of the passenger and prevents said passenger with drawn-up legs from slipping too far forward in the resting position and having to tense the muscles in order to prevent this slipping in the seat.

According to the invention, the adjustment of the leg support and/or foot support may be coupled kinematically to the height adjustment of this front region of the seat surface. For example, it may be provided that when pivoting up the leg support and/or foot support to the substantially vertical stowage position in the direction of a resting position, the end region facing the seat surface of the leg support and/or foot support engages under the front region of the seat surface and in this manner forcibly raises said front region therewith. This kinematic coupling permits an automatic adjustment of the seat surface to a position in which an undesired slipping to the front in a resting position, for example with the knees drawn-up, is substantially prevented.

In a further preferred embodiment, the leg support in the front region of the seat structure is namely pivotably articulated and/or connected at that point to the seat structure, without however having to be directly kinematically coupled to the seat surface itself and/or the front edge thereof. This permits a partial adjustment, or an adjustment which is completely independent of one another, of the seat surface, on the one hand, and leg support, on the other hand. For example, the front region of the seat surface may be raised and independently therefrom the height and/or inclination angle of the leg support may be adjusted. This facilitates the adjustment of a relaxed seating/sleeping position where the seat pitch is small. For example, the front region of the seat surface may be raised in order to prevent slipping to the front in a seating position with drawn-up knees. Independently therefrom, the leg support may be adjusted according to the leg length.

Preferably, a lower region of the backrest may be configured to be displaceable in the longitudinal direction. This embodiment allows the backrest to follow to a certain extent a passenger slipping to the front on the seat surface and thus may support completely, or substantially over the entire surface, the back of a passenger moved forward on the seat surface. To this end, for example, a lower region of the backrest may be configured together with the seat surface to be displaceable in the longitudinal direction.

In a further embodiment of the invention, adjustable padding may be provided fastened to the seat surface and backrest and/or the corresponding regions of the supporting structure of the seat, which may be adjustable such that in a first state with its rear face it bears substantially over the entire surface against the seat surface and backrest and/or the corresponding seat structure and in a second state is configured in a partial region to be unsupported for adapting to the body contours of a passenger. The adjustable padding to a certain extent adopts in this second state a hammock function, in which it is connected to the seat structure only in end regions and is adapted in a central region under tension to the body contours of the passenger. The term “adjustable padding” is intended to express the fact that in this second state the load of a passenger resting on this adjustable padding is received at least partially by the padding material and in the end regions in which the adjustable padding is fastened to the seat surface and/or backrest, the load is diverted into this seat surface or backrest and/or the corresponding supporting structure of the seat.

This embodiment of the invention permits a particularly comfortable design of the seat for a resting or sleeping position, in which the passenger slips further forward in the seat and either stretches the legs below the seat in front or adopts a crouched position described in more detail below, in which the knees are drawn up and the feet are supported on the leg support and/or foot support. Also in this position, the back is substantially supported over the entire surface, so that relaxed sitting or sleeping is possible.

To adjust the adjustable padding, according to the invention the end region of the adjustable padding fastened to the seat surface and/or the corresponding region of the supporting structure and/or the end region of the adjustable padding fastened to the backrest and/or the corresponding region of the supporting structure may be configured to be displaceable in the longitudinal direction and/or vertically. If the end regions are displaced to the rear and/or downward, the entire length of the adjustable padding is sufficient in order to follow the contours of the seat surface and/or backrest, so that the adjustable padding bears with the rear face substantially over the entire surface at that point and forms part of the padding of the seat surface and/or backrest.

In the second state, preferably a central region of the adjustable padding is pulled out to a certain extent from the region in which the seat surface and backrest abut one another and/or merge with one another, and spans this region in the manner of a hammock.

The material of the adjustable padding is preferably sufficiently sturdy in order to absorb the load of a passenger resting on the unsupported region and to divert the load via the fastened end regions into the supporting structure of the seat. The adjustable padding may itself have a thickness of, for example, 1 to 5 cm, in order firstly to be sufficiently sturdy and secondly in the first state, in which it bears with its rear face against the seat structure, to be able to serve as conventional padding.

The seat according to the invention is preferably configured as a shell-type seat. The term shell-type seat means that a fixed seat shell is present, within which the seat surface and backrest are arranged. The seat shell is part of the supporting structure or connected to the supporting structure of the seat. When adjusting the seat surface and/or backrest, said seat surface and/or backrest only move within the fixed seat shell, which thus does not alter its position. Shell-type seats thus offer with closely-spaced seating in an economy or premium economy area of an aircraft the advantages that firstly any adjustment of a seat leaves the foot room and/or knee room unaltered for a passenger sitting behind and secondly a possible support of a person sitting behind against the seat shell of the seat in front is not noticed by the passenger sitting in front, in the same manner as, for example, when supported against a conventional backrest.

According to the invention, the rear face of the seat shell may have a knee pad. In this manner, it is possible for a passenger in a resting position to support one or both knees on the seat shell of the seat in front. By the design as a shell-type seat, the force transmitted from the supported knees to the seat shell is directly diverted into the supporting structure; in particular the backrest of the seat is not directly acted upon by this force.

The subject of the invention is, moreover, a seat arrangement with a plurality of seats according to the invention arranged behind one another. The seat pitch in a seat arrangement according to the invention is preferably 73 to 115 cm, further preferably 81 to 102 cm, further preferably 81 to 94 cm. In this case, it refers to seat pitches which are common in economy class or premium economy class in commercial long-haul aircraft. In the field of air travel the term “seat pitch” denotes the spacing between the seats.

According to the invention, it may be provided that the leg support and/or foot support in the resting position substantially occupies the knee room between a seat and the seat arranged in front and/or the seat shell thereof. It is possible in this manner to support the feet on this leg support and/or foot support and at the same time to support the knees against the seat shell of the seat in front. Due to the longitudinal division of the leg support and/or foot support it is also possible that only one leg adopts this position and the other leg is arranged stretched out below the seat in front.

### BRIEF DESCRIPTION OF THE DRAWINGS

Embodiments of the invention are explained hereinafter with reference to the drawings, in which:

FIG. 1 shows schematically a view of a seat according to the invention from above;

FIGS. 2-4 show schematically an embodiment of the invention in a partially sectioned view from the side in different seating positions;

FIG. 5 shows schematically a second embodiment of the invention;

FIGS. 6-7 show schematically a third embodiment of the invention;

FIG. 8 shows schematically a fourth embodiment of the invention.

### DETAILED DESCRIPTION OF THE INVENTION

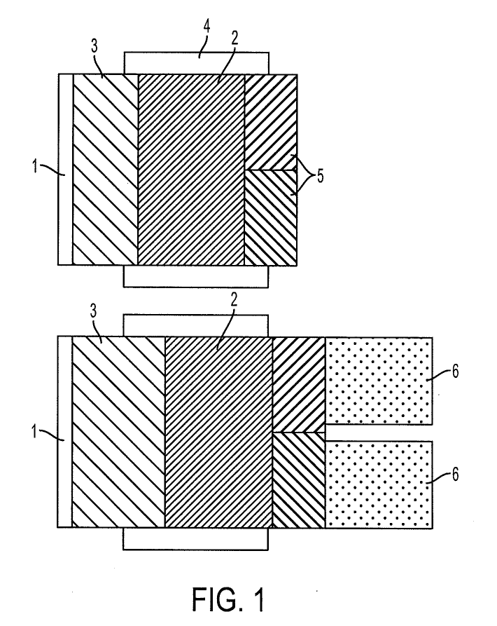

FIG. 1 shows schematically in a view from above a seat with a fixed seat shell 1, in which the seat surface 2 and the backrest 3 are adjustably arranged. The armrests of the seat are indicated at 4. A front region of the seat surface 2 (denoted by the reference numeral 5) is divided in the longitudinal direction, the two halves being separately height-adjustable, as is explained hereinafter in more detail.

The upper half of FIG. 1 shows the seat in a position in which a substantially upright seating position may be adopted. In an aircraft seat, this is, for example, the position for take-off and landing.

In the lower half of FIG. 1, the seat may be seen in a position which, for example, may be set during the flight. The seat surface 2 is pushed to the front within the seat shell 1, and as a result the angle of inclination of the backrest 3 has increased, the lower region thereof being connected to the seat surface 2. A leg support and/or foot support 6 divided in the longitudinal direction is folded upwards from a substantially vertical stowage position facing downwards, and adopts a position which permits the support of the legs and/or feet.

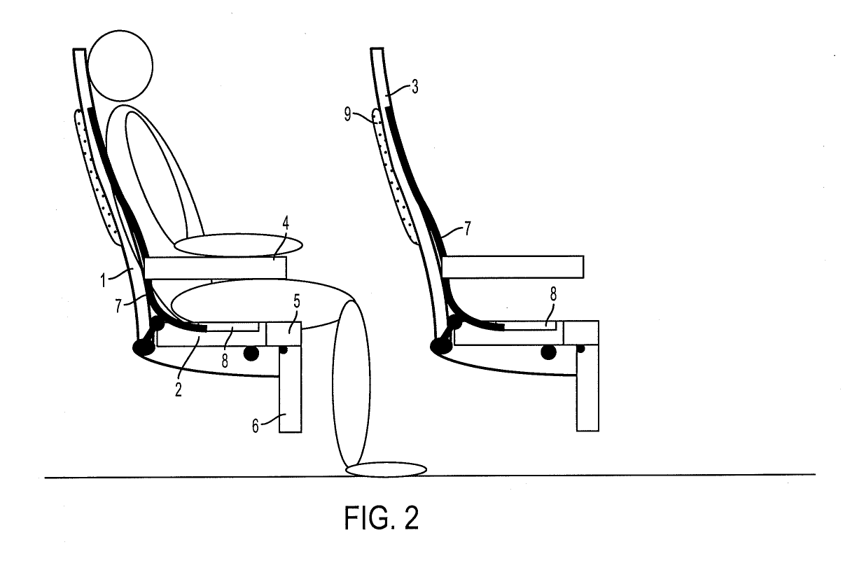

FIG. 2 shows a seat according to the invention in a setting for a substantially upright seating position, for example during take-off and landing. In this position, the leg supports and/or foot supports 6 are folded substantially vertically downwards into a stowage position. This embodiment of the invention has adjustable padding denoted by 7, the upper end region thereof being fastened to the backrest and the lower end region thereof being able to be displaced to the front and/or to the rear over a path indicated at 8 on the seat surface 2. In the seating position shown in FIG. 2, said adjustable padding 7 bears with its rear face facing the seat structure substantially over the entire surface on the seat surface 2, on the one hand, and the backrest 3, on the other hand. In a rear region 9, the seat shell 1 is provided with a knee pad.

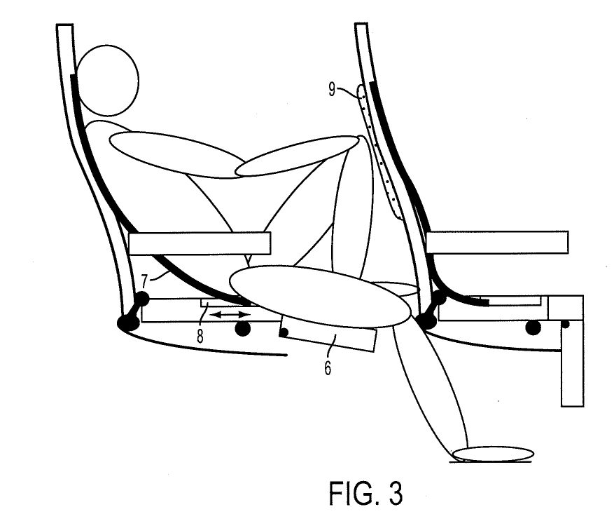

FIG. 3 shows the seat in a further setting. The lower end region of the adjustable padding 7 is displaced to the front within the adjustment path 8, so that the central region of the adjustable padding 7 is unsupported in the manner of a hammock, and in this case supports the back of a passenger slipped forward in the seat. The passenger has, in the seating position shown in FIG. 3, moved the left half of the leg support and/or foot support into a substantially horizontal position and uses this as a foot support. The right-hand half of the leg support and/or foot support 6 is adjusted slightly at an angle downwards from the horizontal position, so that the passenger may support the right upper leg thereon and stretch the right leg under the seat in front.

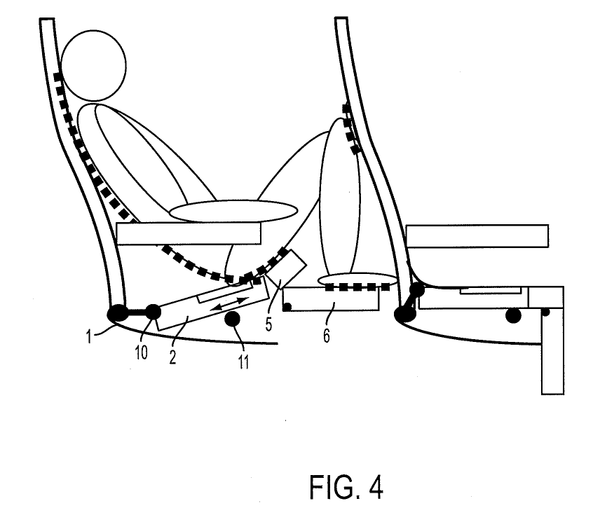

In a further seating position shown in FIG. 4, the seat surface 2 is pushed to the front by means of the double joint indicated at 10, and the rear region of the seat surface 2 facing the backrest has been slightly lowered within the seat shell 1. The front region of the seat surface 2 is slightly raised by the support of the seat surface 2 at 11. The front end region 5 of the seat surface 2 is here additionally raised again. It is visible that the end region of the leg support and/or foot support 6 facing the seat surface 2 has engaged under and raised the front end region 5 of the seat surface. The lifting of the leg support and/or foot support 6 thus leads in a kinematically coupled manner to a raising also of the front end region 5. The leg supports and/or foot supports 6 are both in a substantially horizontal position in which, as shown in FIG. 4, they are used as foot supports. FIG. 4 indicates by dotted regions where the body of the passenger is supported in this seating position. It is visible that in this case a support is provided over a relatively large surface area which permits a relaxed seating position.

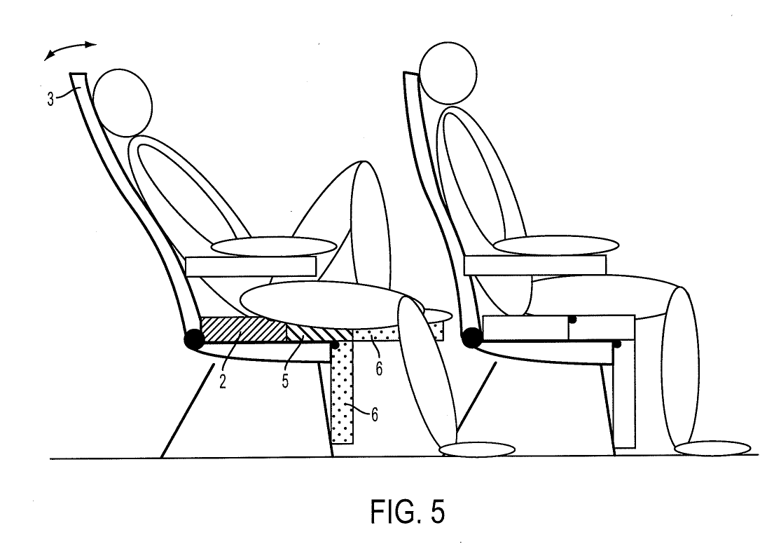

FIG. 5 shows a further embodiment of the invention, in which a seat shell is not present. The backrest 3 in this case may be adjusted as a whole in inclination. In the position shown, the right-hand half of the leg support and/or foot support 6 is in the stowage position facing substantially vertically downwards, the left-hand half is in a substantially horizontal position in which it serves as a foot support.

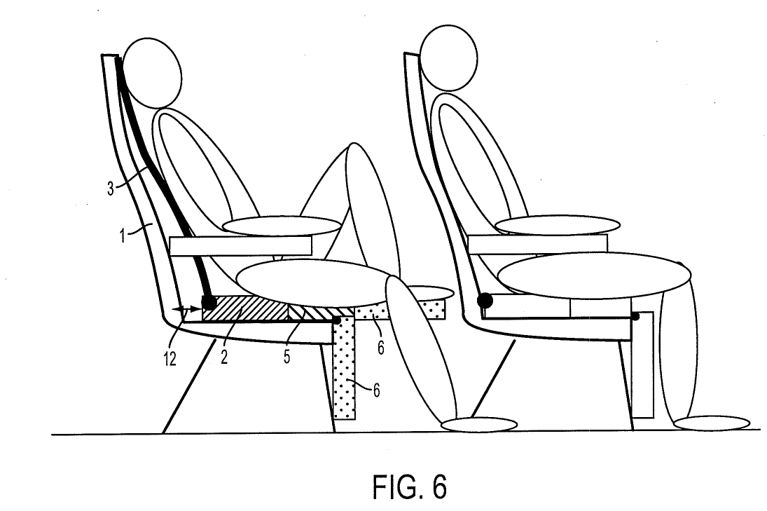

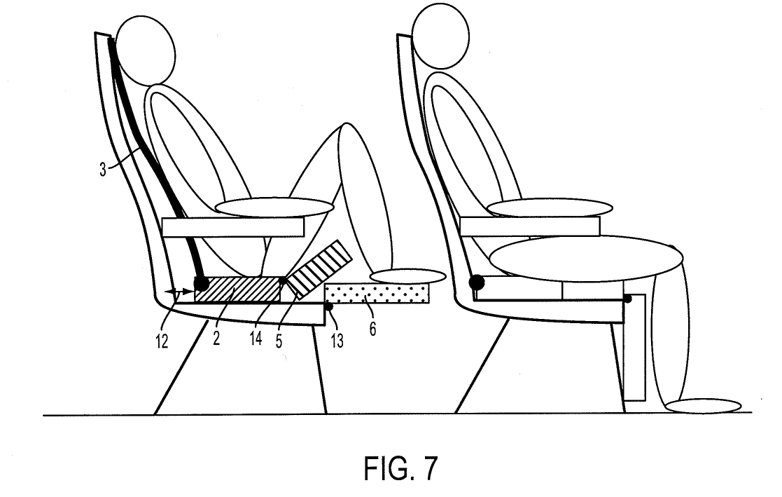

FIGS. 6 and 7 show a further embodiment of the invention. In this case, within a seat shell 1 a seat surface 2 is arranged which is displaceable over the path indicated by the arrow 12 to the front and/or to the rear. The backrest 3 is articulated to the rear end region of the seat surface 2, the angle of inclination thereof thus being adjusted therewith when displacing the seat surface 2.

In the variant shown in FIG. 7, both halves of the leg support and/or foot support 6 are folded upwards about a point of articulation and/or an axis of articulation 13. In this connection, the end region of the leg support and/or foot support 6 facing the seat surface 2 also slightly raises the longitudinally-divided front region 5 of the seat padding 2 as a result of the folding-up process. It is visible that the end region of the leg support and/or foot support 6 facing the seat surface 2 is also raised by the folding-up and/or swinging-up process about the point of articulation 13, engages under the front region 5 of the seat surface 2, and raises said front region and/or pivots up said front region about the point of articulation and/or the axis of articulation 14. By means of this raised front region 5 of the seat surface 2, a passenger is prevented in the resting position from slipping too far forward out of the seat.

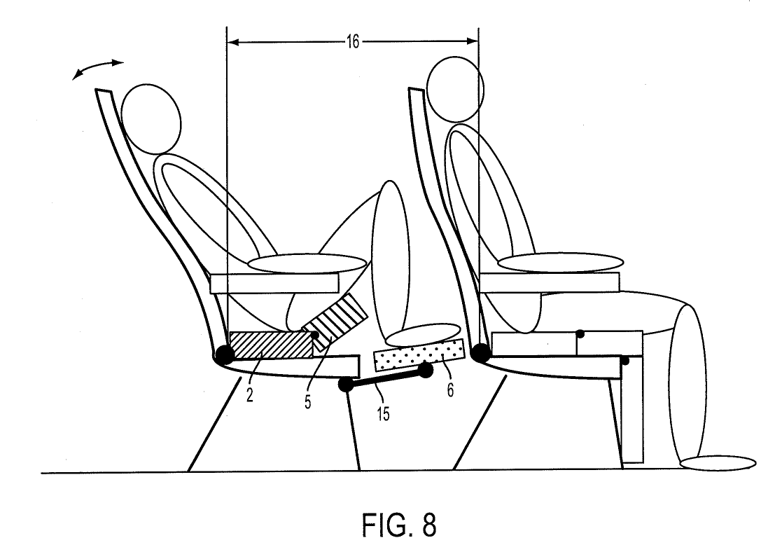

In FIG. 8, a variant is shown in which the leg support and/or foot support 6 is directly connected by means of a pivotable connection 15 to the seat structure (the base frame), and may be adjusted independently of the seat surface 2 and/or the front end region 5 thereof. The front end region 5 may be moved into the position shown in FIG. 8, in order to facilitate sitting with drawn-up legs and/or knees. Irrespective thereof, the height and angle of inclination of the leg support 6 may be adjusted by means of the pivotable connection 15. Even with a small seat pitch 16, a comfortable seating position may be set.

In particular in FIGS. 4, 7 and 8, seating positions are shown in which the leg support and/or foot support 6 of the resting position shown, substantially occupies the knee room between the seat and the seat arranged in front. “Substantially occupy” means in this context that at least 60%, preferably at least 70, 80 and/or 90% of the spacing in the longitudinal direction between the seat surface front edge and the seat shell or backrest of the seat arranged in front may be taken up by the folded-up leg support and/or foot support.

1. A seat for a vehicle, comprising:
a seat surface;
a backrest; and
an adjustable support arranged in a region in front of the seat surface and divided in a longitudinal direction into two separately adjustable parts.

2. The seat of claim 1, wherein the support is pivotably articulated in a region of the front edge of the seat surface.

3. The seat of claim 1, wherein the support is configured to move into a resting position, in which it forms a substantially horizontal support surface.

4. The seat of claim 3, wherein the substantially horizontal support surface of the support in the resting position is arranged approximately at the same height as the seat surface.

5. The seat of claim 3, wherein the substantially horizontal support surface of the support in the resting position has a height within the range of 30 to 60 cm.

6. The seat of claim 5, wherein a front region of the seat surface is configured to be height-adjustable.

7. The seat of claim 6, wherein the support and the seat surface are kinematically coupled such that adjustment of the support toward the resting position raises the front region of the seat surface.

8. The seat of claim 1, wherein a lower region of the backrest is displaceable in the longitudinal direction.

9. The seat of claim 1, wherein a lower region of the backrest and the seat surface are together displaceable in the longitudinal direction.

10. The seat of claim 1, further comprising adjustable padding fastened to the seat surface and the backrest, wherein the adjustable padding is adjustable into a first state in which its rear face bears substantially over the entire surface of the seat surface and the backrest and a second state in which a partial region of the adjustable padding is unsupported so as to adapt to body contours of a passenger.

11. The seat of claim 10, wherein an end region of the adjustable padding fastened to the seat surface is displaceable in the longitudinal direction.

12. The seat of claim 10, wherein an end region of the adjustable padding fastened to the backrest is displaceable vertically.

13. The seat of claim 1, wherein the seat is configured as a shell-type seat.

14. The seat of claim 13, wherein a rear face of a shell of the seat has a knee pad.

15. A seat system comprising a plurality of seats according to claim 1 arranged behind one another.

16. The seat system of claim 15, wherein the seat pitch is within the range of 73 to 115 cm.

17. The seat system of claim 15, wherein a seat's support, in a resting position, substantially occupies knee room between the seat and a seat arranged immediately in front thereof.

18. The seat of claim 1, wherein the support is adapted to support a passenger's leg.

19. The seat of claim 1, wherein the support is adapted to support a passenger's foot.

20. The seat of claim 3, wherein the substantially horizontal support surface of the support in the resting position has a height within the range of 40 to 50 cm.

21. The seat system of claim 15, wherein the seat pitch is within the range of 81 to 102 cm.

22. The seat system of claim 15, wherein the seat pitch is within the range of 81 to 94 cm.
